(19) United States
(12) Patent Application Publication
(10) Pub. No.: US 2022/0300269 A1
(43) Pub. Date: Sep. 22, 2022

(54) INFORMATION PROCESSING APPARATUS, INFORMATION PROCESSING SYSTEM, AND INFORMATION PROCESSING METHOD

(71) Applicant: Dongzhe ZHANG, Kanagawa (JP)

(72) Inventor: Dongzhe ZHANG, Kanagawa (JP)

(21) Appl. No.: 17/671,589

(22) Filed: Feb. 15, 2022

(30) Foreign Application Priority Data
Mar. 22, 2021 (JP) 2021-047977

(51) Int. Cl. G06F 8/65; G06F 9/445

(52) U.S. Cl. CPC G06F 8/65; G06F 9/44505

(57) ABSTRACT

An information processing apparatus includes circuitry. The circuitry creates a function definition relating to an item of application setting information for implementing an application, stores, in a memory, the function definition in association with the application configured to use the function definition, and applies, as the application setting information, the function definition to a plurality of applications including the application stored in association with the function definition.

### CROSS-REFERENCE TO RELATED APPLICATIONS

This patent application is based on and claims priority pursuant to 35 U.S.C. § 119(a) to Japanese Patent Application No. 2021-047977, filed on Mar. 22, 2021, in the Japan Patent Office, the entire disclosure of which is hereby incorporated by reference herein.

### BACKGROUND

### Technical Field

The present disclosure relates to an information processing apparatus, an information processing system, and an information processing method.

### Related Art

There is known a technique in which, when workflow definition information (an example of function definition) defining a workflow (processing flow) including a series of programs (an example of application) is edited, a user is allowed to set editing conditions of the workflow using a user interface (UI), and the workflow definition information is updated (edited) according to the editing conditions.

### SUMMARY

In one aspect, an information processing apparatus includes circuitry. The circuitry creates a function definition relating to an item of application setting information for implementing an application, stores, in a memory, the function definition in association with the application configured to use the function definition, and applies, as the application setting information, the function definition to a plurality of applications including the application stored in association with the function definition.

In another aspect, an information processing system includes an information processing apparatus including circuitry. The circuitry creates a function definition relating to an item of application setting information for implementing an application, stores, in a memory, the function definition in association with the application configured to use the function definition, and applies, as the application setting information, the function definition to a plurality of applications including the application stored in association with the function definition.

In another aspect, an information processing method includes creating a function definition relating to an item of application setting information for implementing an application, storing, in a memory, the function definition in association with the application configured to use the function definition, and applying, as the application setting information, the function definition to a plurality of applications including the application stored in association with the function definition.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a diagram illustrating an example of a configuration of an information processing system according to one embodiment;

FIG. 2 is a block diagram illustrating a hardware configuration of a personal computer (PC) and a service providing system according to one embodiment;

FIG. 3 is a block diagram illustrating a hardware configuration of a multifunction peripheral/product/printer (MFP), which is an example of a device according to one embodiment;

FIG. 4 is a block diagram illustrating an example of a functional configuration of the service providing system according to one embodiment;

FIG. 5 is a block diagram illustrating an example of a functional configuration of a function definition registration unit included in the service providing system according to one embodiment;

FIG. 6 is a block diagram illustrating an example of a functional configuration of a function definition management unit included in the service providing system according to one embodiment;

FIG. 7 is a sequence chart illustrating an example of a flow of function definition update processing in the service providing system according to one embodiment;

FIG. 8 is a conceptual diagram illustrating an example of a user interface (UI) used for registering a function definition provided by the service providing system according to one embodiment;

FIG. 9 is a conceptual diagram illustrating an example of a UI used for applying a function definition provided by the service providing system according to one embodiment;

FIG. 10 is a conceptual diagram illustrating an example of a UI used for editing a function definition provided by the service providing system according to one embodiment;

FIG. 11 is a table illustrating an example of a function definition information storing table stored in a storing unit of the service providing system according to one embodiment;

FIG. 12A is a diagram illustrating an example of defining a function in the service providing system according to one embodiment;

FIG. 12B is a diagram illustrating an example of defining a function in the service providing system according to one embodiment;

FIG. 13 is a conceptual diagram illustrating an example of collective application of a function definition to a plurality of pieces of application information in the service providing system according to one embodiment;

FIG. 14 is a conceptual diagram illustrating an example of collective application of a function definition to a plurality of pieces of application information in the service providing system according to one embodiment;

FIG. 15 is a conceptual diagram illustrating an example of collective application of a function definition to a plurality of pieces of application information in the service providing system according to one embodiment; and

FIG. 16 is a conceptual diagram illustrating an example of collective application of a function definition to a plurality of pieces of application information in the service providing system according to one embodiment.

The accompanying drawings are intended to depict embodiments of the present invention and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Hereinafter, a detailed description is given of an information processing system, an information processing apparatus, and an information processing method according to embodiments of the present disclosure, with reference to the drawings.

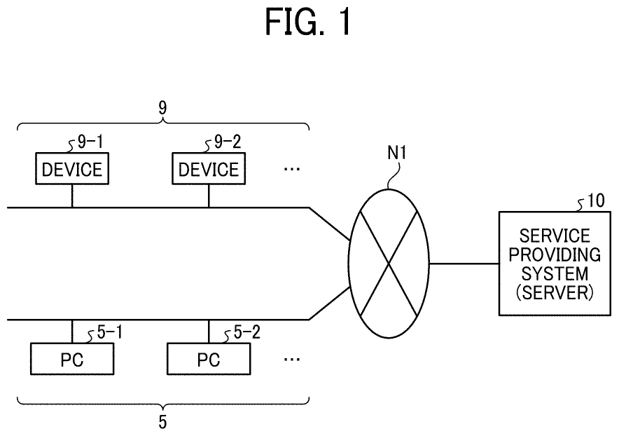

FIG. 1 is a diagram illustrating an example of a configuration of an information processing system according to the present embodiment. As illustrated in FIG. 1, the information processing system according to the present embodiment includes a service providing system 10 (an example of an information processing apparatus) implemented by one or more servers, a plurality of devices 9-1, 9-2, and 9-n, and a plurality of personal computers (PCs) 5-1, 5-2, and 5-n. Here, the “n” is an integer equal to or greater than 1. In the following description, the plurality of devices 9-1, 9-2, and 9-n is collectively referred to as the devices 9 and the plurality of PCs 5-1, 5-2, and 5-n is collectively referred to as the PCs 5 unless particularly distinguished from each other. The service providing system 10, the devices 9, and the PCs 5 are communicably connected to one another via a network N1 such as the Internet.

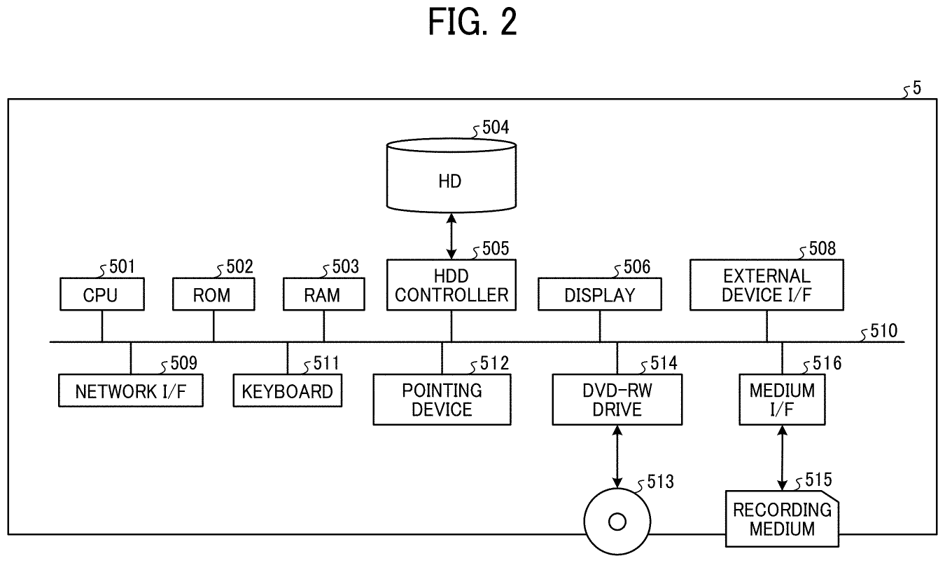

FIG. 2 is a block diagram illustrating a hardware configuration of each of a PC and a service providing system according to the present embodiment. Below, a description is given of a hardware configuration of a server as an example of the service providing system 10. The PC 5 has the same or substantially the same hardware configuration as the hardware configuration of the service providing system 10.

As illustrated in FIG. 2, the service providing system 10 is implemented by a computer and includes a central processing unit (CPU) 501, a read only memory (ROM) 502, a random access memory (RAM) 503, a hard disk (HD) 504, a hard disk drive (HDD) controller 505, a display 506, an external device interface (I/F) 508, a network I/F 509, a data bus 510, a keyboard 511, a pointing device 512, a digital versatile disc rewritable (DVD-RW) drive 514, and a medium I/F 516.

The CPU 501 controls entire operation of the service providing system 10. The ROM 502 stores a program such as an initial program loader (IPL) used for driving the CPU 501. The RAM 503 is used as a work area for the CPU 501. The HD 504 stores various data such as a program. The HDD controller 505 controls reading and writing of various data from and to the HD 504 under control of the CPU 501. The display 506 displays various information such as a cursor, a menu, a window, characters, or an image. The external device I/F 508 is an interface for connection with various external devices. Examples of the external devices include, but not limited to, a universal serial bus (USB) memory and a printer. The network I/F 509 is an interface for data communication through the network N1. The data bus 510 is an address bus, a data bus, or the like that electrically connects each component, such as the CPU 501, illustrated in FIG. 2.

The keyboard 511 is an example of an input device provided with a plurality of keys that allows a user to input characters, numerals, and various instructions. The pointing device 512 is an example of an input device that allows a user to select or execute various instructions, select an object for processing, and move a cursor being displayed. The DVD-RW drive 514 reads and writes various data from and to a DVD-RW 513, which is an example of a removable recording medium. The removable recording medium is not limited to a DVD-RW and may be digital a versatile disc recordable (DVD-R) or the like. The medium I/F 516 controls reading and writing (storing) of data from and to a recording medium 515 such as a flash memory.

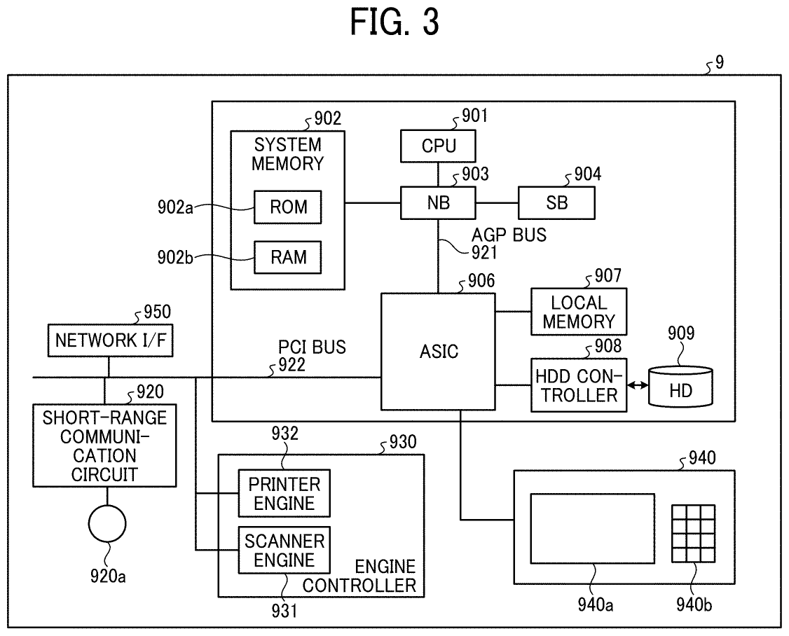

FIG. 3 is a block diagram illustrating a hardware configuration of a multifunction peripheral/product/printer (MFP), which is an example of the device 9 according to the present embodiment. As illustrated in FIG. 3, the MFP as an example of the device 9 includes a controller 910, a short-range communication circuit 920, an engine controller 930, a control panel 940, and a network I/F 950.

The controller 910 includes a CPU 901 as a main processor, a system memory 902, a north bridge (NB) 903, a south bridge (SB) 904, an application specific integrated circuit (ASIC) 906, a local memory 907 as a storage area, an HDD controller 908, and an HD 909 as a storage area. The NB 903 and the ASIC 906 are connected via an accelerated graphics port (AGP) bus 921.

The CPU 901 is a processor that controls entire operation of the MFP (the device 9). The NB 903 is a bridge for connecting the CPU 901 with the system memory 902, the SB 904, and the AGP bus 921. The NB 903 includes a memory controller for controlling reading and writing of various data from and to the system memory 902, a peripheral component interconnect (PCI) master, and an AGP target.

The system memory 902 includes a ROM 902a as a memory that stores a program and data for implementing various functions of the controller 910. The system memory 902 further includes a RAM 902b used as a memory to load the program and the data, or as a drawing memory that stores drawing data for printing. The program stored in the RAM 902b may be stored in any computer-readable recording medium, such as a compact disc read only memory (CD-ROM), a compact disc recordable (CD-R), or a digital versatile disc (DVD), in a file format installable or executable by a computer, for distribution.

The SB 904 is a bridge for connecting the NB 903 to PCI devices and peripheral devices. The ASIC 906 is an integrated circuit (IC) for image processing applications including hardware elements for image processing and has a role of a bridge connecting the AGP bus 921, a PCI bus 922, the HDD controller 908, and the local memory 907 one another. The ASIC 906 includes a PCI target, an AGP master, an arbiter (ARB) as a central processor of the ASIC 906, a memory controller to control the local memory 907, a plurality of direct memory access controllers (DMACs), and a PCI unit. The DMACs rotate image data by converting coordinates of the image data with, for example, a hardware logic. The PCI unit transfers data between a scanner engine 931 and a printer engine 932 via the PCI bus 922. The ASIC 906 may be configured to connect to a universal serial bus (USB) interface, the Institute of Electrical and Electronics Engineers 1394 (IEEE1394) interface, or both.

The local memory 907 is a memory used as a buffer for image data to be copied or a code buffer. The HD 909 is a storage for storing image data, font data used during printing, and forms. The HDD controller 908 controls reading and writing of data from and to the HD 909 under control of the CPU 901. The AGP bus 921 is a bus interface for a graphics accelerator card, which has been proposed to accelerate graphics processing. Through directly accessing the system memory 902 by high-throughput, speed of the graphics accelerator card is improved.

The short-range communication circuit 920 includes a short-range communication antenna 920a. The short-range communication circuit 920 is a communication circuit in compliance with the near field communication (NFC), BLUETOOTH, or the like. The engine controller 930 includes the scanner engine 931 and the printer engine 932. The control panel 940 includes a panel display 940a and an operation panel 940b. The panel display 940a is, for example, a touch panel that displays current settings or a selection screen and receives a user input. The operation panel 940b includes, for example, a numeric keypad and a start key. The numeric keypad receives assigned values of image forming parameters such as an image density parameter. The start key receives an instruction to start copying, for example. The controller 910 controls entire operation of the MFP (the device 9). For example, the controller 910 controls rendering, communication, or user inputs to the control panel 940. The scanner engine 931 and the printer engine 932 each performs various image processing, such as error diffusion or gamma conversion.

Note that, in response to an instruction to select a specific application through the control panel 940 by use of, for example, an application (or mode) switch key, the MFP (the device 9) selectively performs document server function, copying function, printing function, and facsimile communication function. When the document server function is selected, an operation mode switches to a document box mode. With selection of the copying function, the operation mode switches to a copy mode. With selection of the printing function, the operation mode switches to a printer mode. With selection of the facsimile communication function, the operation mode switches to a facsimile mode.

The network I/F 950 is an interface for performing data communication using the communication network N1. The short-range communication circuit 920 and the network I/F 950 are electrically connected to the ASIC 906 via the PCI bus 922.

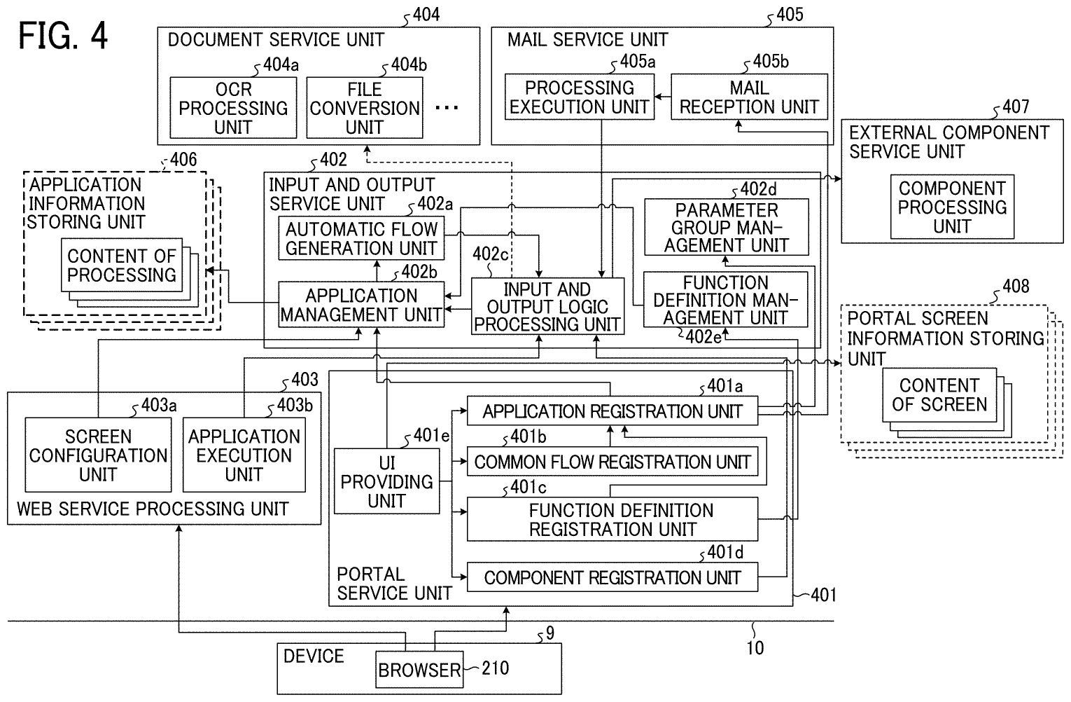

FIG. 4 is a block diagram illustrating an example of a functional configuration of the service providing system according to the present embodiment. The device 9 illustrated in FIG. 4 includes a browser 210 executed by, for example, the CPU 901 and requests the service providing system 10 to execute an application. The browser 210 allows a user of the device 9 to use each of various services including a “scan translation service.” That is, as far as the device 9 includes the browser 210, the device 9 does not necessarily have, for example, a dedicated application program for using each of the various services provided by the service providing system 10.

The service providing system 10 illustrated in FIG. 4 includes a portal service unit 401, an input and output service unit 402, a web service processing unit 403, a document service unit 404, a mail service unit 405, and an external component service unit 407. The portal service unit 401 includes an application registration unit 401a, a common flow registration unit 401b, a function definition registration unit 401c, a component registration unit 401d, and a user interface (UI) providing unit 401e.

Each of the above-mentioned functional units is implemented by processing executed by the CPU 501 according to one or more programs installed on the service providing system 10.

The service providing system 10 further includes an application information storing unit 406 and a portal screen information storing unit 408. Each of the above-mentioned storing units is implemented by, for example, the HD 504. Alternatively, at least one of the above-mentioned storing units may be implemented by a storage device connected to the service providing system 10 through the network N1.

The input and output service unit 402 executes processing relating to a service provided by the service providing system 10. The input and output service unit 402 includes an automatic flow generation unit 402a, an application management unit 402b, an input and output logic processing unit 402c, a parameter group management unit 402d, and a function definition management unit 402e.

The application management unit 402b manages application information stored in the application information storing unit 406. The application information includes processing flow information and application setting information. Note that the application information is information relating to an application program for using a service implemented by a series of processing. In other words, the various services provided by the service providing system 10 are provided by the application, based on the application information.

Further, in response to a request from the input and output logic processing unit 402c, the application management unit 402b transmits processing flow information included in the application information to the input and output logic processing unit 402c. The processing flow information defines a flow of a series of processing (hereinafter “processing flow”) that implements a service provided by the application information.

Furthermore, in response to a request from the portal service unit 401, the application management unit 402b causes the application information storing unit 406 to store the application information. Accordingly, the application information of the application providing the service is registered in the service providing system 10.

The automatic flow generation unit 402a generates the processing flow information included in the application information managed by the application management unit 402b. In response to a request from the application registration unit 401a, the parameter group management unit 402d registers a parameter group or acquires a registered parameter group. The function definition management unit 402e manages a function definition corresponding to a parameter of a component on the processing flow defined by the processing flow information managed by the application management unit 402b. In other words, in response to a request from the function definition registration unit 401c to be described later, the function definition management unit 402e registers application setting information including the function definition.

In response to a request from the web service processing unit 403, the input and output logic processing unit 402c acquires the processing flow information included in the application information from the application management unit 402b. Further, the input and output logic processing unit 402c executes the processing flow for implementing the service provided by the application information according to the processing flow information acquired from the application management unit 402b. Accordingly, the service providing system 10 according to the present embodiment provides the various services including the “scan translation service.”

The web service processing unit 403 performs processing for a user to use the various services by operating the browser 210 of the device 9. That is, the web service processing unit 403 serves as an application server that provides the browser 210 with a web application (application information). The web service processing unit 403 includes a screen configuration unit 403a and an application execution unit 403b.

In response to a request from the browser 210, the screen configuration unit 403a transmits application screen information stored in an application screen information storing unit and the application setting information included in the application information stored in the application information storing unit 406 to the browser 210.

The application screen information defines a template of a screen (application screen) for using a service provided by the application information. The application screen information defines the template of the application screen with, for example, hypertext markup language (HTML), extensible hypertext markup language (XHTML), cascading style sheets (CSS), or JAVA SCRIPT.

The application setting information defines various settings of an application (application information). For example, the application setting information defines a parameter input by a user, a parameter set by default, and the like, among parameters used for executing the processing flow. The application setting information further defines, for example, an input item for the user to input the parameter on the application screen, display information of the application screen (e.g., an application name), and the like. The application setting information defines various application settings with, for example, JavaScript Object Notation (JSON) or the like.

By the above-described operations of the browser 210, the application screen for using the service provided by the service providing system 10 is displayed on a display of the device 9.

In response to a request from the browser 210, the application execution unit 403b transmits a request for executing the application to the input and output service unit 402.

The document service unit 404 executes particular processing included in the processing flow according to the processing flow information. The document service unit 404 includes an optical character recognition (OCR) processing unit 404a and a file conversion unit 404b.

The OCR processing unit 404a performs OCR processing on an electronic file. The file conversion unit 404b compresses or decompresses the electronic file and converts a data format of the electronic file.

The mail service unit 405 includes a processing execution unit 405a and a mail reception unit 405b. The processing execution unit 405a generates an e-mail having the electronic file and transmits the e-mail to an e-mail address designated by, for example, a user. The mail reception unit 405b receives the e-mail.

The portal service unit 401 performs processing for a user to register an application using the browser 210 of the device 9. The portal service unit 401 includes the user interface (UI) providing unit 401e, the application registration unit 401a, the common flow registration unit 401b, the function definition registration unit 401c, and the component registration unit 401d.

In response to a request from the browser 210, the UI providing unit 401e transmits portal screen information stored in the portal screen information storing unit 408 to the browser 210. A portal is a website on which an application is registered using the browser 210.

The portal screen information defines various screens such as a portal top screen and an application registration screen. The portal screen information defines the various screens using the browser 210, for example, such as HTML, extensible markup language (XML), cascading style sheets (CSS), or JAVA SCRIPT.

Accordingly, the browser 210 displays the portal top screen and the application registration screen on a display of the PC 5. As a result, a user of the PC 5 performs an operation to register the application (application information) on the application registration screen.

In response to a request from the UI providing unit 401e, the application registration unit 401a requests the application management unit 402b to register the application (application information). That is, in response to an application registration operation performed on the application registration screen, the application registration unit 401a requests the application management unit 402b to register the application.

In response to a request from the UI providing unit 401e, the common flow registration unit 401b requests the application management unit 402b to register processing flow information common to a plurality of applications through the application registration unit 401a.

In response to a request from the UI providing unit 401e, the function definition registration unit 401c requests the function definition management unit 402e to register application setting information including a function definition through the application registration unit 401a.

In response to a request from the UI providing unit 401e, the component registration unit 401d requests the input and output logic processing unit 402c to register a component. The component registration unit 401d generates the component and transmits the component to the input and output logic processing unit 402c. Generating the component means expanding the component, which is defined by, for example, a class or a function, to a memory such as the RAM 503.

The application information storing unit 406 stores the application information. The application information is stored in the application information storing unit 406 in association with an application identifier (ID) for identifying the application information. The application ID is, for example, a uniform resource locator (URL) of the application information or identification information included in the URL of the application information.

The application information includes the processing flow information and the application setting information. For example, the application information of the application that provides the scan translation service includes the processing flow information defining a series of processing for implementing the scan translation service and the application setting information defining various settings of the application. Hereinafter, the application that provides the scan translation service is also referred to as a “scan translation application.”

The application information may include two or more pieces of the processing flow information and two or more pieces of the application setting information.

As described above, the processing flow information defines the series of processing (processing flow) for implementing the service provided by the application information.

Also, as described above, the application setting information defines the various settings of the application (application information).

The portal screen information storing unit 408 stores the portal screen information. The portal screen information is stored in the portal screen information storing unit 408 in association with the URL of the portal top screen or the application registration screen.

Each of the input and output service unit 402, the web service processing unit 403, the document service unit 404, and the portal service unit 401 may be implemented by a different information processing apparatus.

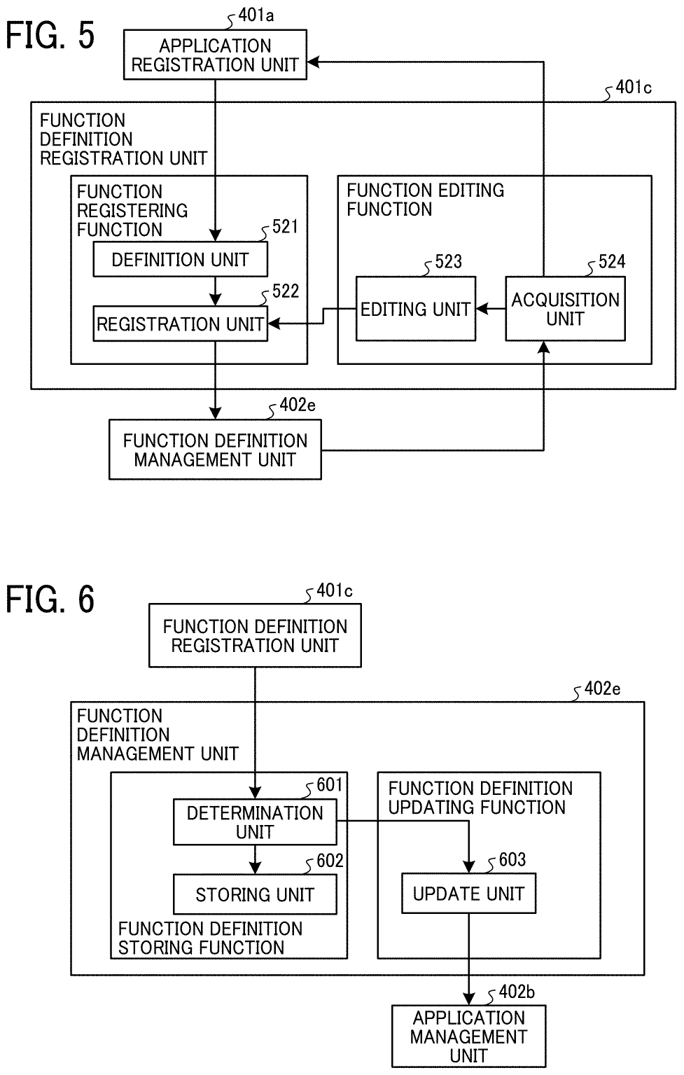

FIG. 5 is a block diagram illustrating an example of a functional configuration of a function definition registration unit included in the service providing system according to the present embodiment. In the present embodiment, as illustrated in FIG. 5, the function definition registration unit 401c includes a definition unit 521, a registration unit 522, an editing unit 523, and an acquisition unit 524.

The definition unit 521 is an example of a creation unit that provides a user (application developer) with a UI for selecting or defining (creating) a new function definition from existing application setting information. The function definition is information relating to a setting item for executing an application, and the setting item includes, for example, a UI, a term, an input format, or a validation condition of the application. Further, the function definition may be associated with a plurality of parameters having a dependency relationship across a plurality of components.

The registration unit 522 transmits a function definition registration request to register a function definition selected or defined by the definition unit 521 or a function definition edited by the editing unit 523 to the function definition management unit 402e. The function definition edited by the editing unit 523 is described later.

The acquisition unit 524 acquires a list of function definitions registered in the function definition management unit 402e and selects a function definition to be checked or edited from the acquired list of function definitions.

The editing unit 523 provides a UI for checking or editing the function definition acquired by the acquisition unit 524 and updates the function definition with the edited function definition through the registration unit 522 using the UI.

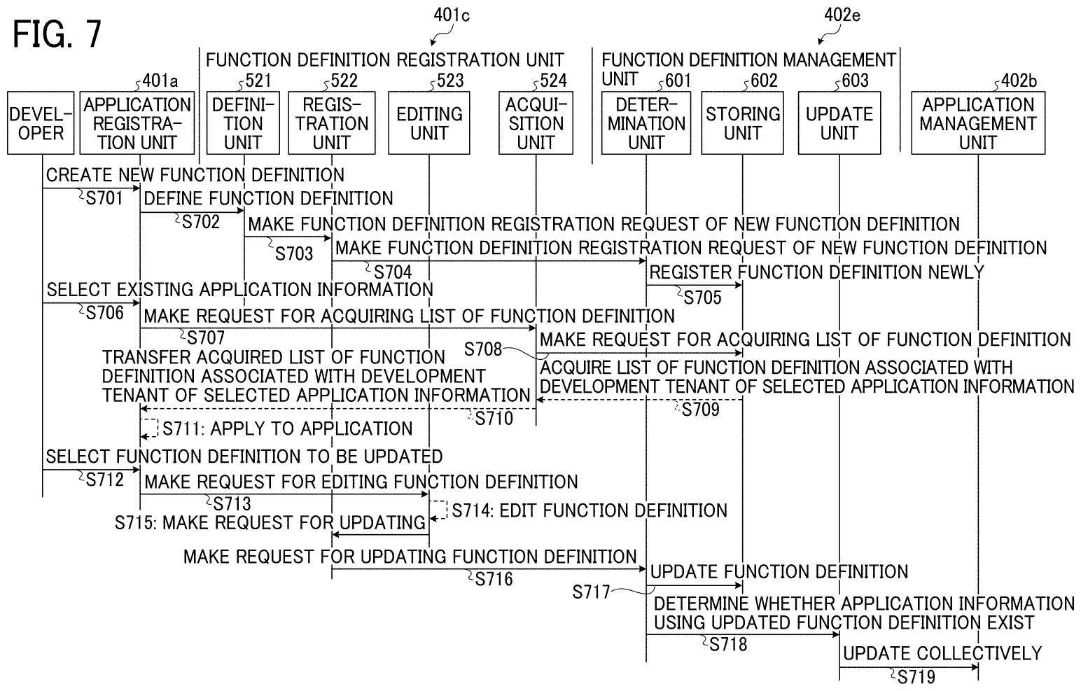

FIG. 6 is a block diagram illustrating an example of a functional configuration of a function definition management unit included in the service providing system according to the present embodiment. In the present embodiment, as illustrated in FIG. 6, the function definition management unit 402e includes a determination unit 601, a storing unit 602, and an update unit 603.

The determination unit 601 receives the function definition registration request from the function definition registration unit 401c (in particular, the registration unit 522 illustrated in FIG. 5) and stores (saves) the function definition in the storing unit 602. Further, the determination unit 601 determines whether or not there is any existing application using the function definition included in the function definition registration request. When there is an existing application using the function definition included in the function definition registration request, the determination unit 601 requests the update unit 603 to update the application setting information of the existing application.

The storing unit 602 is an example of a storing unit that stores the function definition included in the function definition registration request and information (e.g., application name) of the application using the function definition in association with each other. In the present embodiment, the storing unit 602 stores the function definition, tenant information indicating a development tenant that has created the function definition, and the information of the application created by the development tenant in association with one another.

In response to an update request from the determination unit 601, the update unit 603 collectively updates the respective application setting information of the existing applications using the function definition included in the function definition registration request. That is, the update unit 603 is an example of an applying unit that applies, as the application setting information, the function definition included in the function definition registration request to the application information stored in the storing unit 602 in association with the function definition. The update unit 603 applies the function definition to the application information stored in the storing unit 602 in association with the function definition included in the function definition registration request and the tenant information indicating the development tenant that has created the function definition.

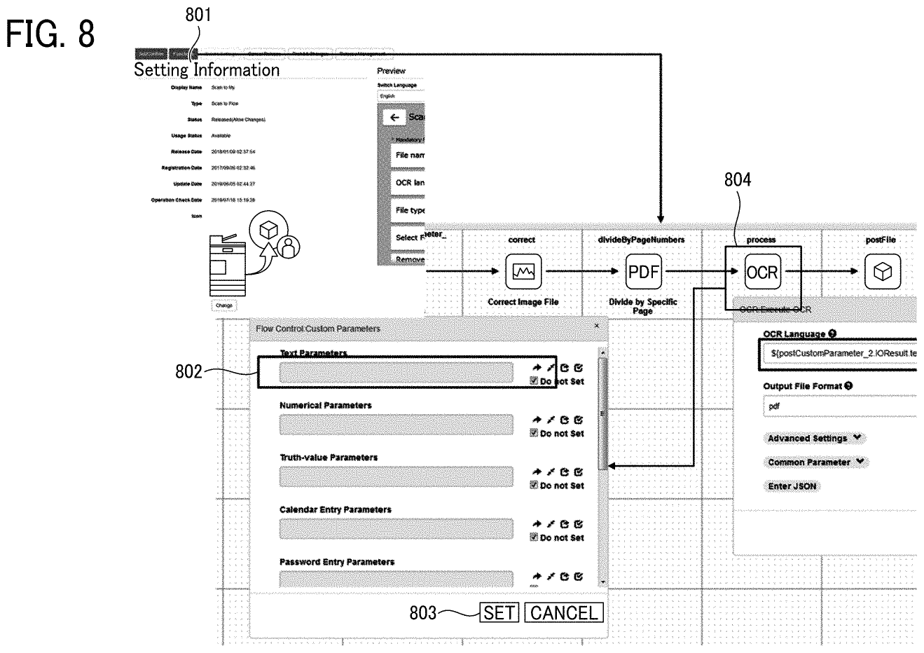

FIG. 7 is a sequence chart illustrating an example of a flow of function definition update processing in the service providing system according to the present embodiment. Referring now to FIG. 7, a description is given of the flow of function definition update processing in the service providing system according to the present embodiment.

A developer assigned with the tenant information selects a piece of existing application information registered by the application registration unit 401a, creates a new function definition for existing application setting information corresponding to a parameter of a component in the selected piece of the application information using the UI provided by the definition unit 521 (S701), and the definition unit 521 receives the new function definition (S702). The definition unit 521 transmits a function definition registration request (registration request) for newly registering the function definition to the determination unit 601 through the registration unit 522 (S703, S704). The determination unit 601 stores (newly registers) the function definition in the function definition registration request transmitted from the registration unit 522 in the storing unit 602 in association with the selected application information and the tenant information (S705).

Further, the developer selects the piece of existing application information registered by the application registration unit 401a (S706) and requests the acquisition unit 524 to acquire a list of function definitions registered in the function definition management unit 402e (S707). The acquisition unit 524 requests the storing unit 602 to acquire the list of function definitions associated with the development tenant of the selected piece of application information (S708) and acquires the list of function definitions associated with the development tenant of the selected piece of application information among a list of function definitions registered in the function definition management unit 402e (S709). The acquisition unit 524 transfers the acquired list of function definitions to the application registration unit 401a (S710). The application registration unit 401a applies the list of function definitions acquired by the acquisition unit 524 to the selected piece of application information (S711).

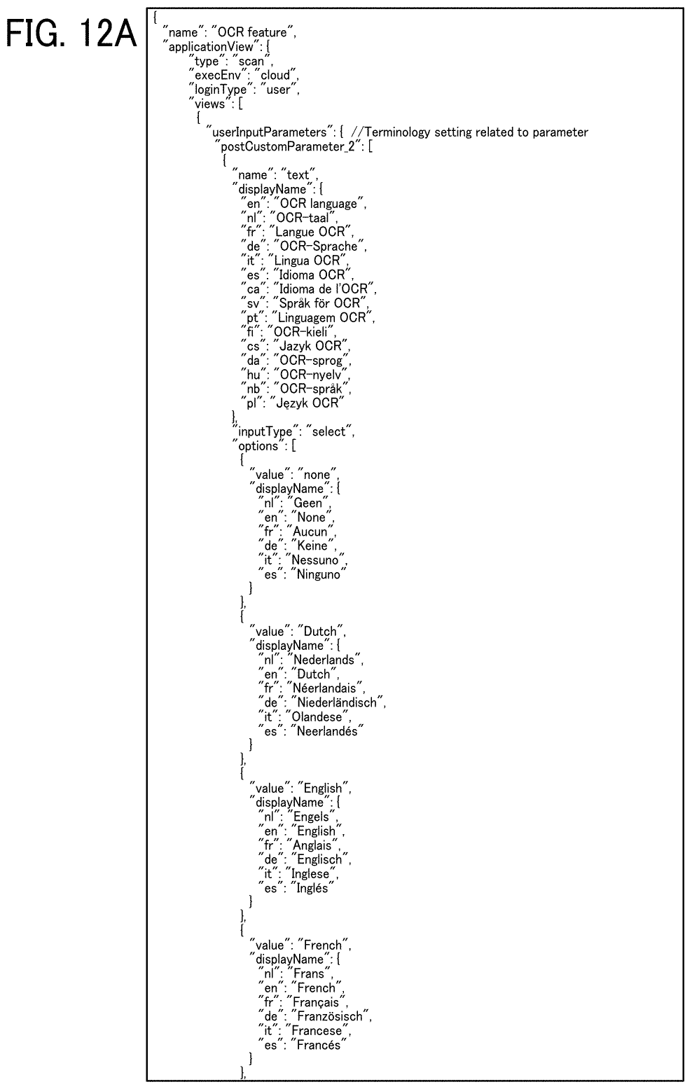

Further, the developer selects a function definition to be updated among the list of function definitions acquired by the acquisition unit 524 using the UI provided by the definition unit 521 (S712) and requests the editing unit 523 to edit the selected function definition (S713). The editing unit 523 edits the selected function definition (S714) and requests the determination unit 601 to update the selected function definition with the edited function definition through the registration unit 522 (S715, S716). The determination unit 601 updates the selected function definition stored in the storing unit 602 with the edited function definition (S717). The determination unit 601 refers to determines whether or not there is any piece of the application information using the selected function definition updated with the edited function definition (that is, a piece of application information associated with the updated function definition), referring to a function definition information storing table (association information) illustrated in FIG. 11 (S718). When there is one or more applications (application information) using the function definition that has been edited, the determination unit 601 collectively updates, through the update unit 603, the applications using the function definition that has been edited (S719).

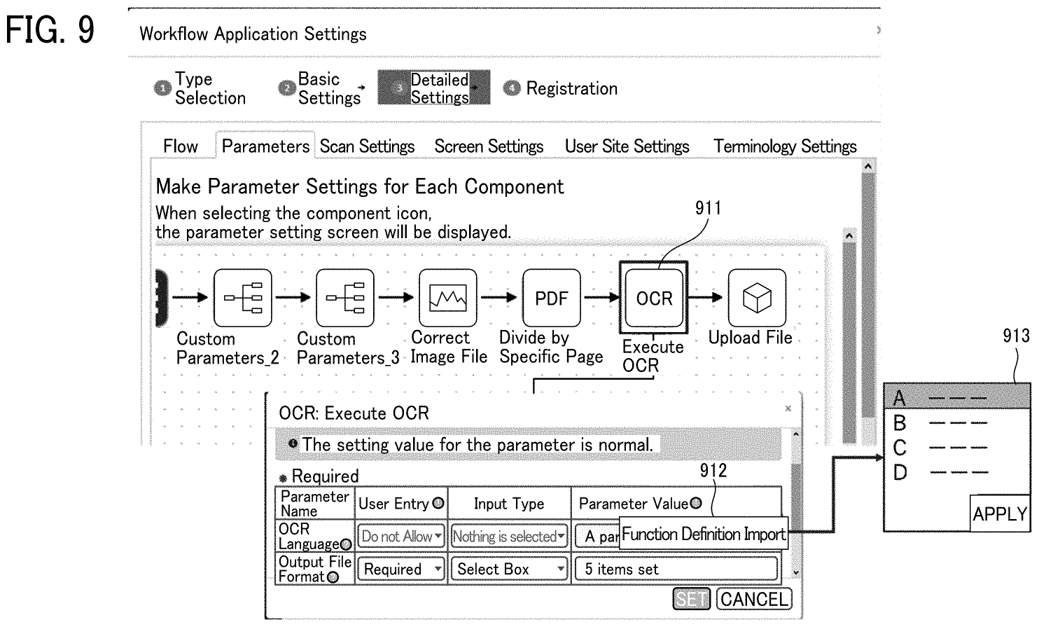

FIG. 8 is a conceptual diagram illustrating an example of a UI used for registering a function definition provided by the service providing system according to the present embodiment. In the present embodiment, as illustrated in FIG. 8, the definition unit 521 provides a UI including a function definition registration button 801, a parameter selection field 802, a function registration button 803, a parameter list display request button 804, and the like. The function definition registration button 801 is a button for requesting a start to register a function definition. The parameter selection field 802 is a field for selecting a parameter of a component corresponding to the function definition to be registered. The function registration button 803 is a button for requesting registration of the function definition. The parameter list display request button 804 is a button for requesting to display a list of parameters of the component corresponding to the function definition to be registered.

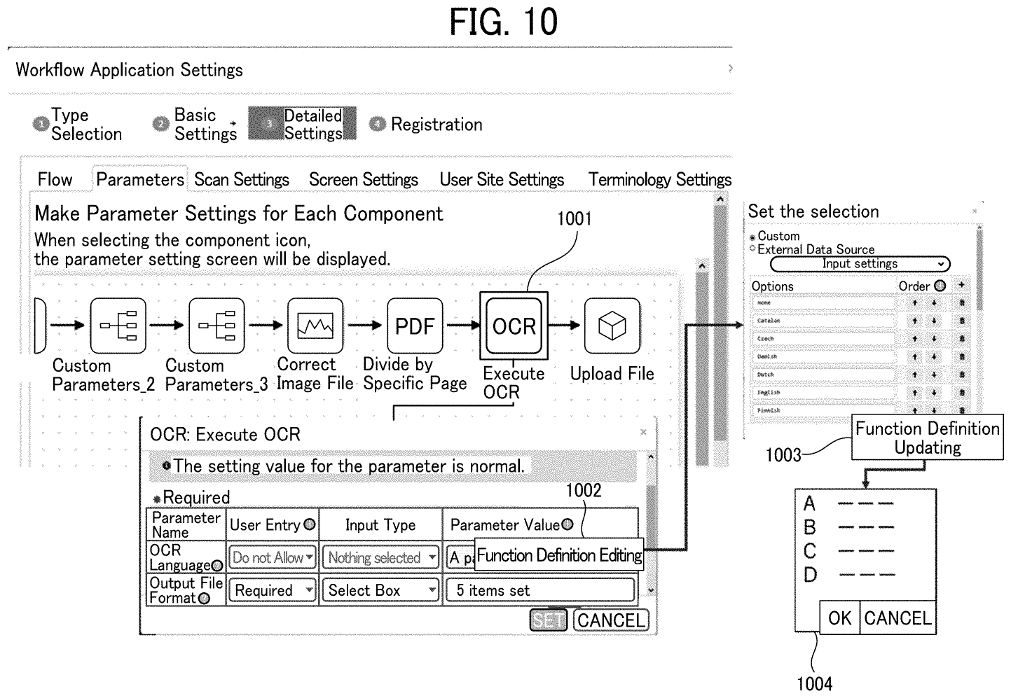

FIG. 9 is a conceptual diagram illustrating an example of a UI used for applying a function definition provided by the service providing system according to the present embodiment. In the present embodiment, as illustrated in FIG. 9, the definition unit 521 provides a UI including a parameter setting button 911, a function definition import button 912, and the like. The parameter setting button 911 is a button for requesting to display a parameter of an existing component. The function definition import button 912 is a button for requesting import of an applicable function definition. In response to a request of function definition import from the function definition import button 912, the definition unit 521 displays a list 913 of applicable function definitions and transmits a function definition registration request for a function definition selected by, for example, the developer, from the list 913 to the function definition management unit 402e through the registration unit 522.

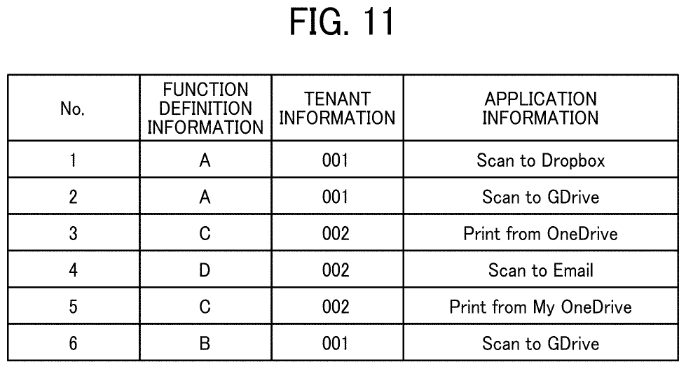

FIG. 10 is a conceptual diagram illustrating an example of a UI used for editing a function definition provided by the service providing system according to the present embodiment. In the present embodiment, as illustrated in FIG. 10, the editing unit 523 provides a UI including a parameter setting button 1001, a function definition editing button 1002, a function definition updating button 1003, and the like. The parameter setting button 3/21 is a button for requesting to display a parameter of an existing component. The function definition editing button 1002 is a button for requesting editing of a function definition. The function definition updating button 1003 is a button for requesting update of the function definition. In response to a request of function definition update from the function definition updating button 1003, the editing unit 523 displays a list 1004 of applications associated with the function definition to be updated.

FIG. 11 is an example of the function definition information storing table stored in a storing unit of the service providing system according to the present embodiment. In the present embodiment, as illustrated in FIG. 11, the storing unit 602 stores a function definition, tenant information indicating a development tenant that has created the function definition, and a piece of application information of the application using the function definition in association with one another. When the function definition is edited, the update unit 603 collectively applies the edited function definition to all pieces of application information associated with the function definition that has been edited in the function definition information storing table.

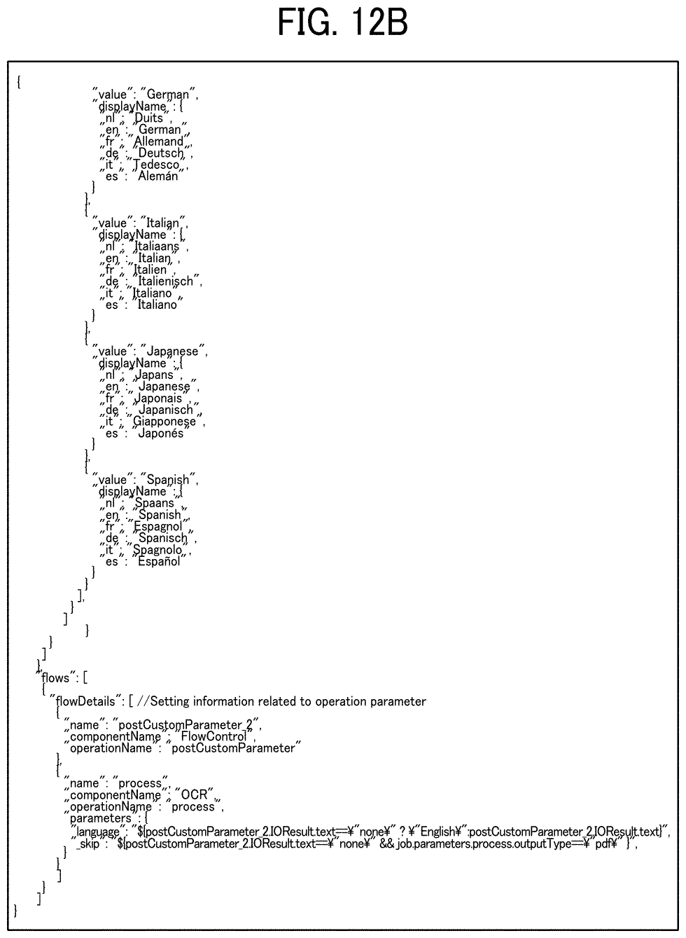

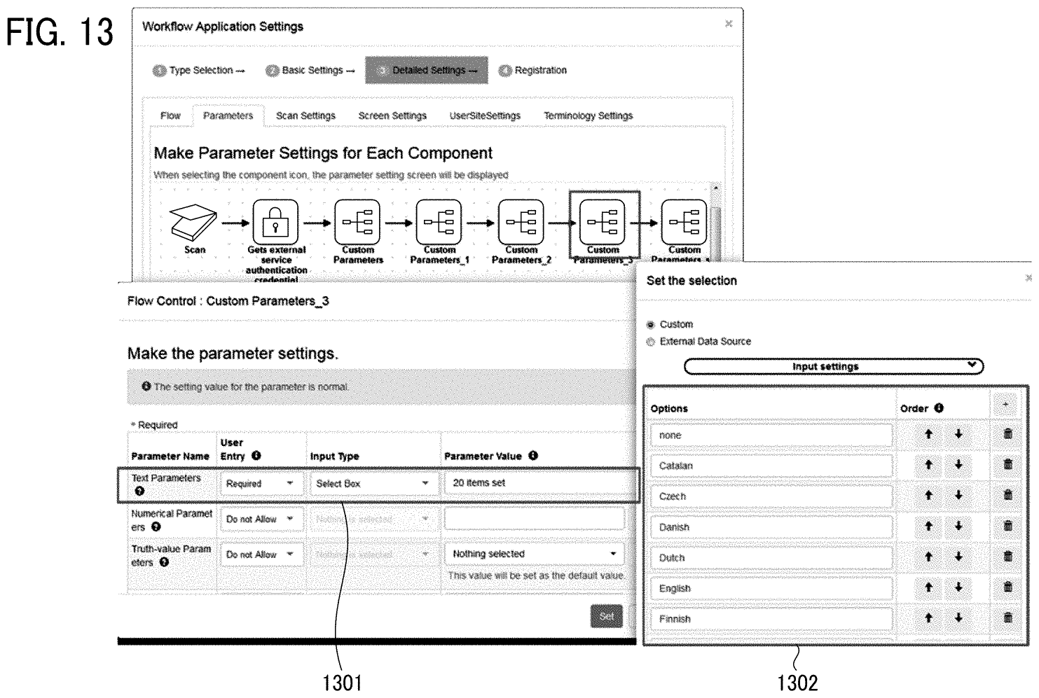

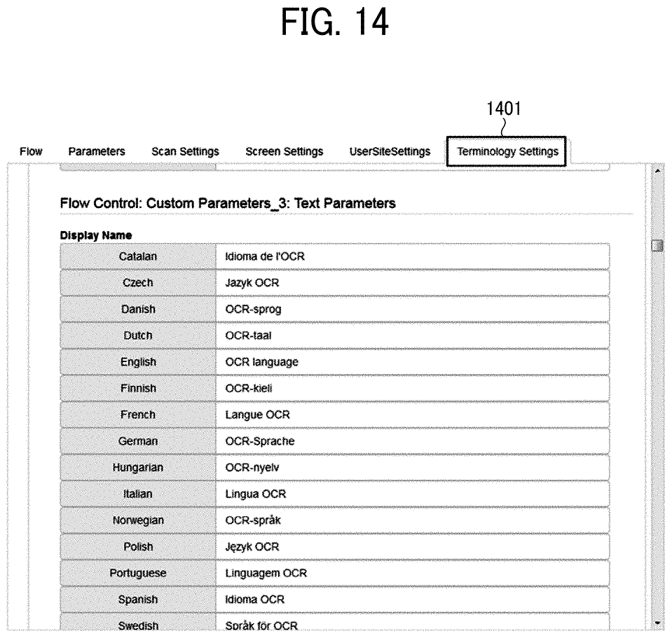

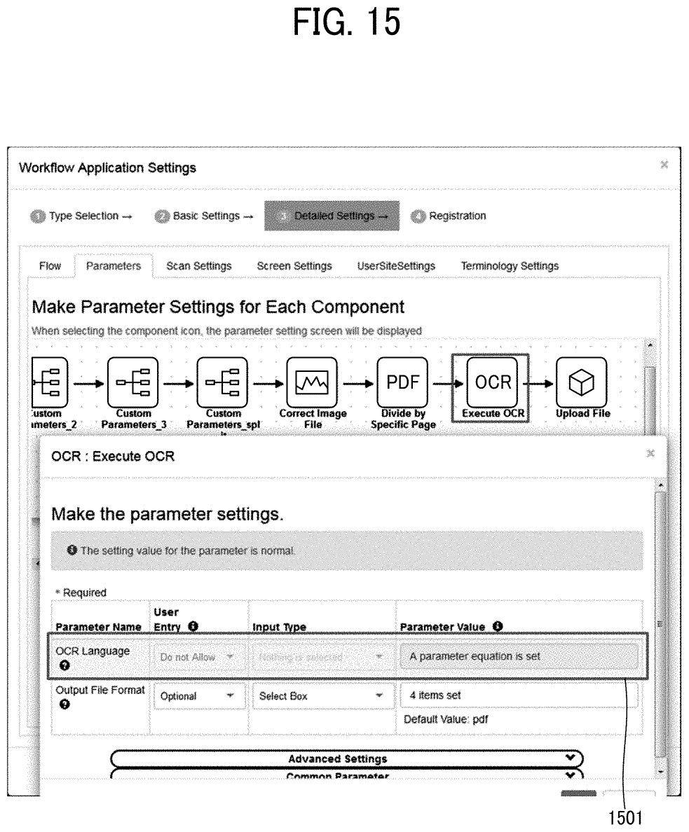

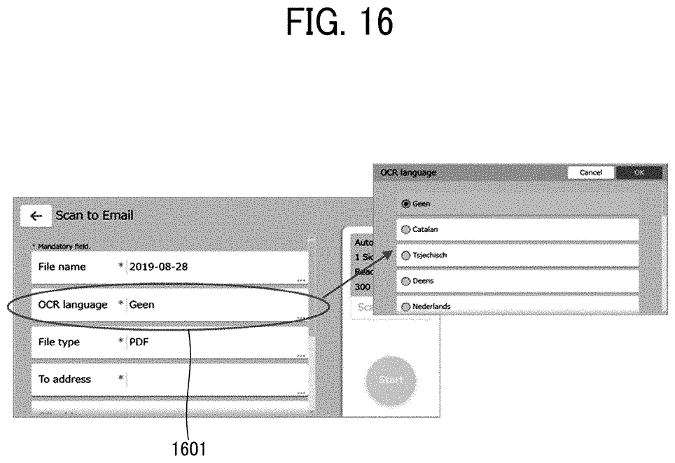

FIGS. 12A and 12B are diagrams illustrating an example of defining a function in the service providing system according to the present embodiment. FIGS. 13 to 16 are conceptual diagrams illustrating an example of collective application of a function definition to a plurality of pieces of application information in the service providing system according to the present embodiment. For example, as illustrated in FIGS. 12A and 12B, the definition unit 521 defines, as function definitions, items of the application setting information associated with a parameter of an OCR component such as a UI, a term, an input format, and a validation condition. The OCR is an example of the application. In this case, the update unit 603 applies the defined application setting information to the application information of OCR. Further, as illustrated in FIGS. 13 to 16, the update unit 603 collectively applies the defined application setting information to the UI and setting (fields 1301 and 1302, a field 1401, a field 1501, and a field 1601 in FIGS. 13 to 16) of other pieces of application information associated with the edited function definition.

As described above, according to the service providing system 10 of the present embodiment, when a function definition of one application is defined or edited, the defined or edited function definition is automatically applied to another application using the function definition. Thus, a common setting used in a plurality of applications is appropriately and easily updated.

Each function of the above-described embodiment may be implemented by one or more processing circuits or circuitry. Processing circuitry includes a programmed processor, as a processor includes circuitry. A processing circuit also includes devices such as an application specific integrated circuit (ASIC), a digital signal processor (DSP), a field programmable gate array (FPGA), and conventional circuit components arranged to perform the recited functions.

The apparatuses or devices described in the above-described embodiment are merely one example of the plural computing environments that implement the embodiment disclosed herein. In some embodiments, service providing system 10 includes a plurality of computing devices, such as a server cluster. The plurality of computing devices communicates with one another through any type of communication link including, for example, a network or a shared memory, and performs the operations described in the present disclosure. Similarly, the PC 5 may include a plurality of computing devices configured to communicate with one another.

Further, the service providing system 10 and the PC 5 may be configured to share the disclosed processing steps, for example, by combining the functional units of FIG. 4, in various manners. For example, a process executed by a particular unit (e.g., the web service processing unit 403, the document service unit 404, the mail service unit 405, and the external component service unit 407) may be executed by the PC 5. Further, each element of the service providing system 10 and the PC 5 may be integrated into one server or may be divided into a plurality of devices.

The device 9 as an example of various devices is not limited to an image forming apparatus as long as the device has a communication function. The device 9 may be, for example, a projector, an interactive white board (IWB; an electronic white board having a blackboard function capable of mutual communication), an output device such as a digital signage, a head-up display (HUD) device, an industrial machine, an imaging device, a sound collecting device, a medical device, a network home appliance, an automobile (connected car), a laptop PC, a mobile phone, a smartphone, a tablet terminal, a game console, a personal digital assistant (PDA), a digital camera, a wearable PC, or a desktop PC.

The program to be executed in the service providing system 10 according to the present embodiment may be provided by being installed in advance in the ROM 502 or the like. The program to be executed in the service providing system 10 according to the present embodiment may be stored in a computer-readable storage medium, such as a CD-ROM, a flexible disk (FD), a CD-R, and a DVD, in a file format installable or executable by a computer, for distribution.

Further, the program to be executed in the service providing system 10 according to the present embodiment may be stored in a computer connected to a network such as the Internet and provided by being downloaded via the network. Furthermore, the program to be executed in the service providing system 10 according to the present embodiment may be provided or distributed via a network such as the Internet.

The program executed in the service providing system 10 according to the present embodiment has a module configuration including the above-described functional units (the portal service unit 401, the input and output service unit 402, the web service processing unit 403, the document service unit 404, the mail service unit 405, the external component service unit 407). As an actual hardware, as the CPU 501, which is an example of a processor, reads the program from the ROM 502 and executes the program, each of the above-described functional units is loaded onto a main memory. Then, the portal service unit 401, the input and output service unit 402, the web service processing unit 403, the document service unit 404, the mail service unit 405, and the external component service unit 407 are implemented (generated) on the main memory.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

In one aspect, non-transitory recording medium is provided, which, when executed by one or more processors, cause the processors to perform an information processing method including: creating a function definition relating to an item of application setting information for implementing an application; storing, in a memory, the function definition in association with the application configured to use the function definition; and applying, as the application setting information, the function definition to a plurality of applications including the application stored in association with the function definition.

1. An information processing apparatus comprising circuitry configured to:
create a function definition relating to an item of application setting information for implementing an application;
store, in a memory, the function definition in association with the application configured to use the function definition; and
apply, as the application setting information, the function definition to a plurality of applications including the application stored in association with the function definition.

2. The information processing apparatus according to claim 1, wherein the circuitry:
further stores a development tenant that has created the function definition, in association with the function definition and the application created by the development tenant in association with one another; and
applies the function definition to the plurality of application each stored in association with the development tenant that has created the function definition.

3. The information processing apparatus according to claim 1, wherein the circuitry further:
edits the function definition;
updates the function definition stored in the memory with the function definition that has been edited; and
applies the function definition that has been updated to the plurality of applications each application stored in association with the function definition.

4. The information processing apparatus according to claim 1, wherein:
the function definition is associated with a plurality of parameters having a dependency relationship across a plurality of components on a processing flow for implementing the application.

5. An information processing system including an information processing apparatus comprising circuitry configured to:
create a function definition relating to an item of application setting information for implementing an application;
store, in a memory, the function definition in association with the application configured to use the function definition; and
apply, as the application setting information, the function definition to a plurality of applications including the application stored in association with the function definition.

6. An information processing method comprising:
creating a function definition relating to an item of application setting information for implementing an application;
storing, in a memory, the function definition in association with the application configured to use the function definition; and
applying, as the application setting information, the function definition to a plurality of applications including the application stored in association with the function definition.
